(19) United States
(12) Patent Application Publication
(10) Pub. No.: US 2015/0107756 A1
(43) Pub. Date: Apr. 23, 2015

(54) METHOD FOR MANUFACTURING STEERING WHEEL COVER

(71) Applicant: Ho-Chang Lee, New Taipei City (TW)

(72) Inventor: Ho-Chang Lee, New Taipei City (TW)

(21) Appl. No.: 14/307,507

(22) Filed: Jun. 18, 2014

(30) Foreign Application Priority Data
Oct. 17, 2013 (TW) 102137535

(51) Int. Cl. B62D 1/06; B29C 35/02; B29C 47/00

(52) U.S. Cl. CPC B62D 1/06; B29C 47/0066; B29C 47/0064; B29C 35/02
USPC 156/110.1

(57) ABSTRACT

A manufacturing method for manufacturing a steering wheel cover is provided. At least one silicone rubber bar is provided. Two ends of the hollow silicone rubber bar are connected to form a close loop, wherein liquid silicone rubber is applied to a junction of the silicone rubber bar. Then, the hollow silicone rubber bar and the liquid silicone rubber are vulcanized to form the steering wheel cover. Therefore, the efficiency of producing the steering wheel cover is improved and the production costs are reduced.

### CROSS-REFERENCE TO RELATED APPLICATION

This application claims the priority benefit of Taiwan application serial no. 102137535, filed on Oct. 17, 2013. The entirety of the above-mentioned patent application is hereby incorporated by reference herein and made a part of this specification.

### BACKGROUND OF THE INVENTION

1. Field of the Invention

The invention relates to a manufacturing method for manufacturing a steering wheel cover.

2. Description of Related Art

In recent year, automobiles are very commonly used means of transport. The steering wheel is a main component that the driver uses for controlling the automobile, which also makes it one of the parts that are most frequently touched by the driver during driving. Many drivers install steering wheel covers on the steering wheels not only for keeping the steering wheels clean but also for enhancing the touch when the drivers operate the steering wheels so as to prevent unstable driving resulting from slipping of the drivers' hands on the steering wheels.

Most of the traditional steering wheel covers are made of leather or artificial leather, which is cut into small pieces to be stitched into the covers according to the sizes of the steering wheels. However, such a method is slow and costly for production. In addition, leather and artificial leather are less flexible and cannot be disposed tightly on the steering wheels, and dirt and sweat on these types of steering wheel covers are difficult to clean.

Silicone rubber has higher elasticity and tensile strength and has been used to manufacture steering wheel covers in place of the traditional leather or artificial leather. The steering wheel cover made of silicone rubber can be stretched to be installed on the steering wheel closely and tightly for preventing a relative movement that occurs between the steering wheel cover and the steering wheel when the driver controls the steering wheel from affecting driving safety. The conventional silicone rubber steering wheel cover is formed integrally by press molding, which limits the size of the steering wheel cover.

### SUMMARY OF THE INVENTION

The invention provides a manufacturing method for manufacturing a steering wheel cover, which has a larger size range, achieves higher production efficiency, and requires lower production costs.

The manufacturing method of the steering wheel cover of the invention includes the following steps. At least one first silicone rubber bar is provided. Two ends of the first silicone rubber bar are connected to form a close loop, wherein liquid silicone rubber is applied to a junction of the first silicone rubber bar. The first silicone rubber bar and the liquid silicone rubber are vulcanized to form the steering wheel cover.

In an embodiment of the invention, the first silicone rubber bar and the liquid silicone rubber are the same material.

In an embodiment of the invention, the manufacturing method further includes adding a vulcanizing agent to the liquid silicone rubber or solid silicone rubber. The solid silicone rubber is rolled or the liquid silicone rubber is stirred to disperse the vulcanizing agent uniformly. A second silicone rubber bar is extruded. The silicone rubber bar is baked in a drying tunnel. The second silicone rubber bar is cut to form the at least one first silicone rubber bar.

In an embodiment of the invention, the first silicone rubber bar or the second silicone rubber bar has a hollow profile.

Based on the above, the invention provides the manufacturing method that utilizes the liquid silicone rubber to connect two ends of at least one silicone rubber bar to form the close loop for vulcanization, so as to form the steering wheel cover. Accordingly, the manufacturing method of the invention is suitable for manufacturing steering wheel covers of different sizes, improves the production efficiency, and lowers the production costs.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a flowchart of a method for manufacturing a steering wheel cover according to an embodiment of the invention.

FIG. 2 is a schematic diagram of the steering wheel cover manufactured by the method of FIG. 1.

FIG. 3 is a schematic diagram of a steering wheel cover according to another embodiment of the invention.

FIG. 4 is a schematic diagram illustrating the steering wheel cover of FIG. 2 disposed on a steering wheel.

### DESCRIPTION OF THE EMBODIMENTS

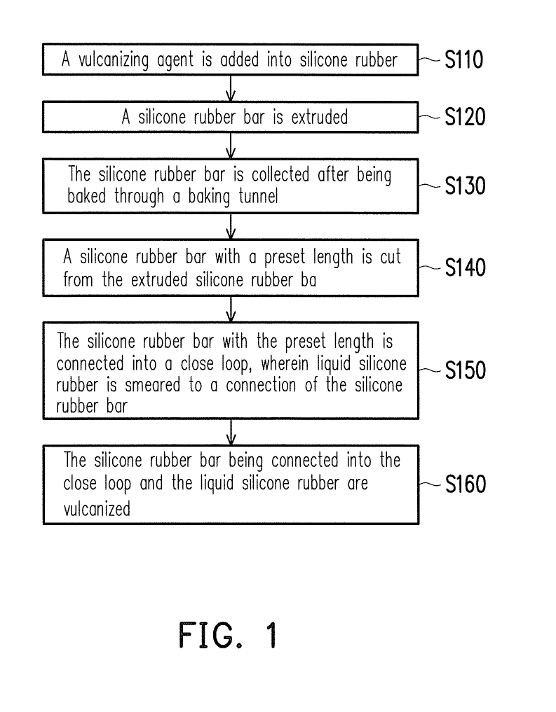

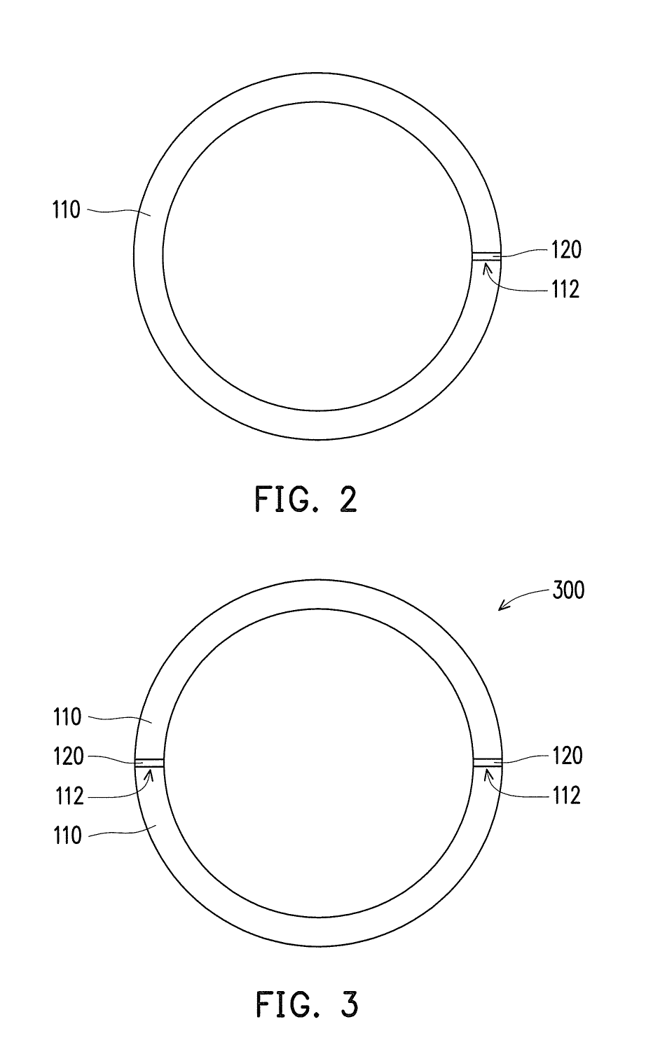

FIG. 1 is a flowchart of a method for manufacturing a steering wheel cover according to an embodiment of the invention. FIG. 2 is a schematic diagram of the steering wheel cover manufactured by the method of FIG. 1. With reference to FIG. 1 and FIG. 2, in this embodiment, the manufacturing method of a steering wheel cover 100 includes the following steps. In Step S110, a vulcanizing agent is added into silicone rubber. In Step S120, a silicone rubber bar is extruded. In Step S130, the silicone rubber bar is collected after being baked in a baking tunnel. In Step S140, the extruded silicone rubber bar is cut into a silicone rubber bar 110 that has a predetermined length. In Step S150, the silicone rubber bar 110 with a preset is connected to form a close loop. In this embodiment, the close loop is circular, but the close loop may be in other shapes, wherein a junction of the silicone rubber bar 110 is applied with liquid silicone rubber 120. In Step S160, the silicone rubber bar 110, which is connected to form the close loop, and the liquid silicone rubber 120 are vulcanized. Accordingly, the steering wheel cover 100 is manufactured by the above steps.

Details are further explained below. First, in Step S110, after adding the vulcanizing agent to solid silicone rubber, the solid silicone rubber is rolled into the silicone rubber, so as to disperse the vulcanizing agent uniformly therein. Moreover, the vulcanizing agent may be added to the liquid silicone rubber and dispersed uniformly by stirring. Next, in Step S120, an extruder is used to extrude the hollow silicone rubber bar so as to obtain longer silicone rubber bar for baking. After the baking in Step S130, the silicone rubber bar is cut into a plurality of silicone rubber bars 110 each having the predetermined length according to the requirement of a size of the steering wheel cover 100. Here, it is not required to consider the length when extruding the silicone rubber bar. That is, in this stage, the manufacturer on the production line may extend the length of the silicone rubber bar as much as possible. After completing the subsequent baking process, the silicone rubber bar is then cut according to the size required. Accordingly, in terms of the length, the silicone rubber bar has higher applicability, which not only improves the production efficiency of the front-end manufacturing (extruding the hollow silicone rubber bar) but also increases the utilization of the extruded silicone rubber bar.

Then, in Step S150 and Step S160, after the silicone rubber bar 110 cut into a proper length is obtained, two ends of the silicone rubber bar 110 is applied with the liquid silicone rubber 120, and the silicone rubber bar 110 is connected in a circular shape (the liquid silicone rubber 120 is depicted thicker in FIG. 2 for clear illustration), wherein the two ends of the silicone rubber bar 110 faun a junction 112. Thereafter, the silicone rubber bar 110 and the liquid silicone rubber 120 applied thereon are vulcanized together, such that the silicone rubber bar 110 forms the steering wheel cover 100 due to the vulcanization of the liquid silicone rubber 120 at the junction.

In this embodiment, the silicone rubber bar 110 and the liquid silicone rubber 120 are the same material. Therefore, after the vulcanization, the liquid silicone rubber 120 bonds the silicone rubber bar 110, and each part of the steering wheel cover 100 that is completely manufactured has the same strength.

FIG. 3 is a schematic diagram of the steering wheel cover according to another embodiment of the invention. A difference between this embodiment and the previous embodiment is that: in this embodiment, a steering wheel cover 300 includes two silicone rubber bars 110. Thus, two junctions 120 are applied with the liquid silicone rubber to be bonded. Based on the above, an annular size of the steering wheel cover 300 of the invention is adjustable. That is, after extruding the silicone rubber bar, the manufacturing method and conditions of the silicone rubber bars 110 can be adjusted as required.

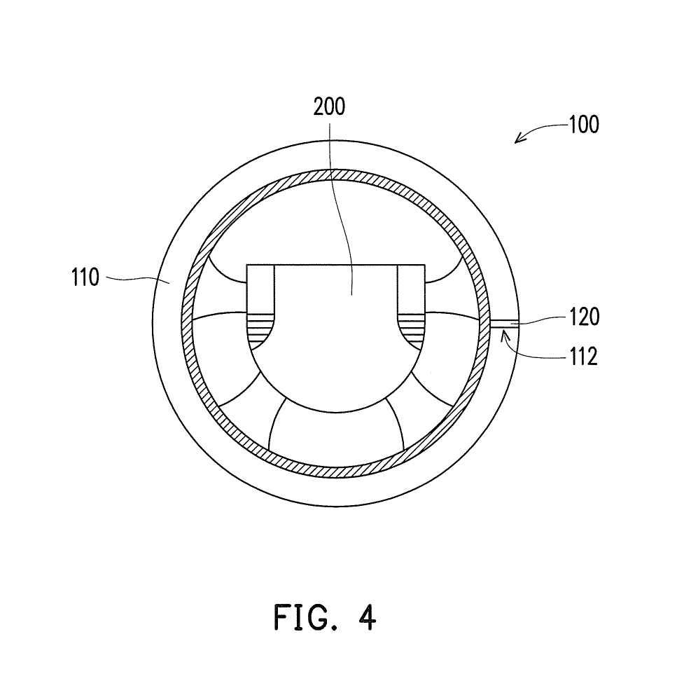

FIG. 4 is a schematic diagram illustrating the steering wheel cover of FIG. 2 disposed on a steering wheel. With reference to FIG. 2, FIG. 3, and FIG. 4, after the steering wheel cover 100 is manufactured using the silicone rubber bar 110 by the manufacturing method of the invention, the steering wheel cover 100 having the hollow profile can be installed on a steering wheel 200 of an automobile, for example.

In conclusion of the above, the manufacturing method of the invention utilizes the liquid silicone rubber to connect the silicone rubber bar into the circular shape for vulcanization, so as to form the steering wheel cover. Moreover, because it is not required to consider the length of the silicone rubber bar during the extrusion, the production efficiency of the production line is improved, and in the subsequent process, the silicone rubber bar can be cut into the predetermined length according to the size of the steering wheel, thereby increasing the material utilization effectively. Further, the number and length of the silicone rubber bars that foam the steering wheel cover can be determined as appropriate according to the size of the steering wheel. Thus, the steering wheel cover of the invention has higher applicability.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A manufacturing method for manufacturing a steering wheel cover, the manufacturing method comprising:
providing at least one first silicone rubber bar;
connecting ends of the at least one first silicone rubber bar to form a close loop, wherein liquid silicone rubber is applied to a junction of the at least one silicone rubber bar; and
vulcanizing the at least one first silicone rubber bar and the liquid silicone rubber to form the steering wheel cover.

2. The manufacturing method according to claim 1, wherein the at least one first silicone rubber bar and the liquid silicone rubber are the same material.

3. The manufacturing method according to claim 1, further comprising:
adding a vulcanizing agent to the liquid silicone rubber or solid silicone rubber;
rolling the solid silicone rubber or stirring the liquid silicone rubber to disperse the vulcanizing agent uniformly;
extruding a second silicone rubber bar;
baking the silicone rubber bar in a drying tunnel; and
cutting the second silicone rubber bar to form the at least one first silicone rubber bar.
